(19) United States
(12) Patent Application Publication
(10) Pub. No.: US 2021/0388865 A1
(43) Pub. Date: Dec. 16, 2021

(54) Composite Crank and Method for Manufacturing the Same

(71) Applicant: KENSTONE METAL CO., LTD., TAICHUNG (TW)

(72) Inventors: Wen-Chang KUO, TAICHUNG (TW); Chun-Yen HUANG, TAICHUNG (TW); Chia-Wei CHANG, TAICHUNG (TW); Po-Yueh CHOU, TAICHUNG (TW)

(21) Appl. No.: 17/342,782

(22) Filed: Jun. 9, 2021

(30) Foreign Application Priority Data
Jun. 12, 2020 (TW) 109119964

(51) Int. Cl. F16C 3/22; B29C 70/86

(52) U.S. Cl. CPC F16C 3/22; B29C 70/86; B29L 2031/7488; F16C 2220/28; F16C 2326/28; F16C 2208/82

(57) ABSTRACT

A composite crank has a first metal member, a second metal member, a connecting space, an external fiber member, and a reinforcement fiber member. The first metal member and the second metal member are arranged at a spaced interval to form the connecting space in the composite crank and between the first metal member and the second metal member. The external fiber member is wrapped on and around the first metal member, the second metal member, and the connecting space. The reinforcement fiber member is disposed between the first metal member and the second metal member and has two overlaying segments respectively bonding to two opposite inner sides of the external fiber member along a thickness direction of the composite crank and a rib disposed in the connecting space and connecting with the two overlaying segments. The composite crank is light in weight, and structural strength in a thickness direction thereof can be enhanced.

### BACKGROUND OF THE INVENTION

### 1. Field of the Invention

The present invention relates to a crank for a bicycle, and more particularly to a crank made of composite materials.

### 2. Description of Related Art

A bicycle usually uses a rigid structural frame to connect a front wheel and a rear wheel. A crank is connected between a chain wheel and a pedal and transmits a riding force by a user to the rear wheel via the chain wheel and the chain. Being a structural component for transmitting power, a bicycle crank is usually made of steel or alloy. To ensure smooth rotation of a pedal end and a chain-wheel end of the crank, the two ends of the crank must have rigid, pivotably connecting structures to bear twisting loads from the pedal end and the chain-wheel end at the same time. In addition, to decrease weight of the bicycle, fiber materials are applied to manufacture the bicycle frame. However, the fiber materials do not have enough strength to produce pivotably connecting structures for bearing high torque. Then the bicycle crank made of composite material including metal and fiber materials is produced.

### SUMMARY OF THE INVENTION

The main objective of the invention is to provide a composite crank and method for manufacturing the same. The composite crank is light in weight, and structural strength in a thickness direction thereof can be enhanced.

In order to achieve the above objective, the present invention provides a composite crank comprising:

a first metal member having
a first connecting hole portion having a first connecting hole; and
a first connection segment extending from the first connecting hole portion and having a first opening formed in an end of the first connection segment away from the first connecting hole portion;

a second metal member arranged at a spaced interval from the first metal member to define a connecting space in the composite crank and between the first metal member and the second metal member, the second metal member having
a second connecting hole portion having a second connecting hole; and
a second connection segment extending from the second connecting hole portion and having a second opening formed in an end of the second connection segment away from the second connecting hole portion, wherein the connecting space communicates with the first opening and the second opening;

an external fiber member wrapped on and around the first metal member, the second metal member, and the connecting space; and

a reinforcement fiber member extending along a connecting direction between the first metal member and the second metal member, disposed between the first metal member and the second metal member, and having
two overlaying segments respectively bonding to two opposite inner sides of the external fiber member along a thickness direction of the composite crank; and
a rib disposed in the connecting space and connecting with the two overlaying segments.

The present invention provides a method for manufacturing a composite crank comprising:

providing a first metal member, a second metal member, and a core member, wherein
the first metal member has
   a first connecting hole portion having a first connecting hole; and
   a first connection segment extending from the first connecting hole portion and having a first opening formed in an end of the first connection segment away from the first connecting hole portion;
the second metal member has
   a second connecting hole portion having a second connecting hole; and
   a second connection segment extending from the second connecting hole portion and having a second opening formed in an end of the second connection segment away from the second connecting hole portion;

forming a reinforcement fiber member in the core member, wherein the reinforcement fiber member has a rib and two overlaying segments, the rib is inserted through the core member, the two overlaying segments respectively connect to two opposite edges of the rib and respectively overlaying on two opposite side surfaces of the core member along a thickness direction of the core member;

inserting two opposite ends of the core member with the reinforcement fiber member into the first opening of the first metal member and the second opening of the second metal member respectively; and

wrapping an external fiber member on the first metal member, the second metal member and the core member, and conducting hot pressing via a mold to combine the external fiber member with the two overlaying segments of the reinforcement fiber member.

A weight of the composite crank of the present invention can be decreased via the external fiber member surrounding the first metal member and the second metal member, and stiffness in the thickness direction of the composite crank can be enhanced via the reinforcement fiber member in the connecting space. The composite crank of the present invention is light in weight, and structural strength in a thickness direction thereof can be enhanced.

### BRIEF DESCRIPTION OF THE DRAWINGS

FIG. 1 is a perspective view of a first embodiment of a composite crank in accordance with the present invention;

FIG. 2 is a cross sectional top side view of the first embodiment of the composite crank in accordance with the present invention showing that the composite crank has a reinforcement fiber member;

FIG. 3A is a cross sectional side view of another embodiment of the composite crank in accordance with the present invention showing that the composite crank has multiple reinforcement fiber members;

FIG. 3B is a cross sectional side view of the first embodiment of the composite crank in accordance with the present invention showing that the composite crank has a reinforcement fiber member;

FIG. 4A is a cross sectional end view of said another embodiment of the composite crank in accordance with the present invention showing that the composite crank has multiple reinforcement fiber members;

FIG. 4B is a cross sectional end view of the first embodiment of the composite crank in accordance with the present invention showing that the composite crank has a reinforcement fiber member;

FIG. 5 is an exploded perspective view of the first embodiment of the composite crank in accordance with the present invention, wherein an external fiber member is omitted;

FIG. 6 is an operational exploded perspective view of the first embodiment of the composite crank in accordance with the present invention showing that the external fiber member is wrapped therearound;

FIG. 7 is an exploded perspective view of a second embodiment of the composite crank in accordance with the present invention, wherein an external fiber member is omitted;

FIG. 8 is an exploded perspective view of a third embodiment of the composite crank in accordance with the present invention, wherein an external fiber member is omitted; and

FIG. 9 is a cross sectional top side of the third embodiment of the composite crank in accordance with the present invention;

FIG. 10 is a side view of the third embodiment of the composite crank in accordance with the present invention;

FIG. 11 is a cross sectional end view of a fourth embodiment of a composite crank in accordance with the present invention; and

FIG. 12 is a block diagram of a method for manufacturing a composite crank.

### DETAILED DESCRIPTION OF THE PREFERRED EMBODIMENT

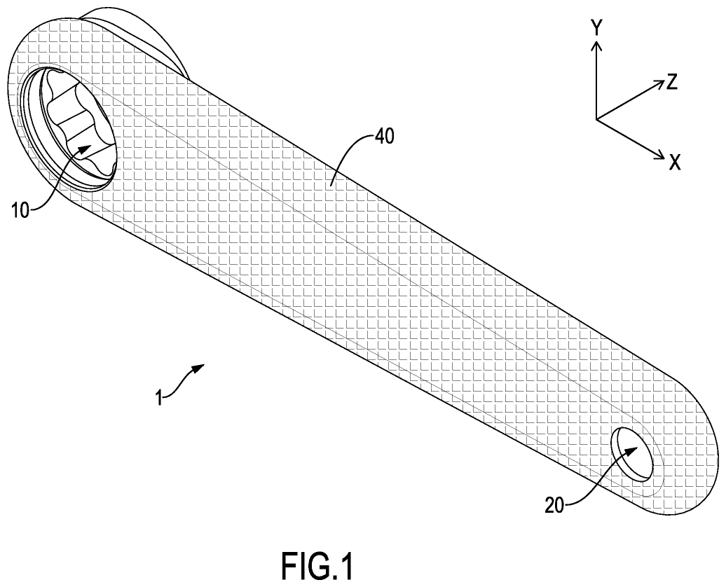

With reference to FIGS. 1, 2, 3A, 3B, 4A, and 4B, a first embodiment of a composite crank 1 in accordance with the present invention is adapted to a bicycle. For the convenience of description, a major axis X, a minor axis Y, and a reference axis Z or a thickness direction of the composite crank 1 are defined in the drawings. The major axis X and the minor axis Y are both perpendicular to the reference axis Z, and the major axis X and the minor axis Y are perpendicular to each other. For the convenience of description, each embodiment of the composite crank 1 in accordance with the present invention is a straight composite crank. In other embodiments of the composite crank 1 in accordance with the present invention, an upper surface, a lower surface, side surfaces, and all components and structures of the composite crank 1 may extend along the reference axis Z, the major axis X, and the minor axis Y, or extend along two or three of the three axises. The composite crank 1 may be curved, twisted, or deflected. Therefore, straightness and uniform thickness are not necessary limitations for the crank.

The composite crank 1 comprises a first metal member 10, a second metal member 20, a connecting space, an external fiber member 40, and one or multiple reinforcement fiber members 30/30a/30b. The composite crank 1 extends along the major axis X. The first metal member 10 and the second metal member 20 are arranged at a spaced interval. The connecting space S is defined between the first metal member 10 and the second metal member 20. The external fiber member 40 is wrapped on and around the first metal member 10, the second metal member 20, and the connecting space S. The reinforcement fiber members 30 is longitudinally formed through the connecting space S and is connected to two opposite inner surfaces of the external fiber member 40. The major axis X is referred to as a connecting direction of the first metal member 10 and the second metal member 20. The minor axis Y is referred to as a width direction of the composite crank 1. The reference axis Z is referred to as a thickness direction of the composite crank 1. The structural strength of the composite crank 1 in the reference axis Z or the thickness direction of the composite crank 1 in accordance with the present invention can be enhanced.

The first metal member 10, e.g. an aluminum member, comprises a first connecting hole portion 11 and a first connection segment 13. The first connecting hole portion 11 has a wavy and annular hole surface and has a first connecting hole 110 defined therein. The first connecting hole 110 extends along the reference axis Z or the thickness direction of the composite crank 1. The first connecting hole portion 11 is adapted to connect to a shaft in a 3-way or five-way hub to combine a down tube, a chain stay and/or a seat tube. In this embodiment, the first connecting hole 110 is a through hole. The first connecting hole 110 can also be a blind hole, or a combination of partial through hole and partial blind hole. The first connection segment 13 extends from the first connecting hole portion 11. For example, it can extend along the major axis X, and has a first opening 132 formed in an end thereof away from the first connecting hole portion 11. The first connection segment 13 has a first width D1 along the minor axis Y.

The second metal member 20 and the first metal member 10 are arranged at a spaced interval to define the connecting space S between contours thereof. For example, the second metal member 20 and the first metal member 10 are arranged along the major axis X at a spaced interval. The second metal member 20 can be an aluminum member and comprises a second connecting hole portion 21 and a second connection segment 23. The second connecting hole portion 21 is defined as a second connecting hole 210 extending through the reference axis Z or the thickness direction of the composite crank 1. The second connecting hole 210 is adapted to connect with a pedal of the bicycle. In this embodiment, the second connecting hole 210 is a through hole. The second connecting hole 210 can be a blind hole. The second connection segment 23 extends from the second connecting hole portion 21. For example, it extends along the major axis X toward the first metal member 10, and has a second opening 232 formed in an end thereof near the first metal member 10. The second connection segment 23 has a second width D2 along the minor axis Y.

The connecting space S is formed in the composite crank 1, is located between the first metal member 10 and the second metal member 20, and communicates with the first opening 132 and the second opening 232. Preferably, the first connection segment 13 further has a first cavity 131 formed in the first connection segment 13 and communicating with the first opening 132. A periphery of the first cavity 131 is formed as a first surrounding wall 133 that surrounds the first cavity 131. The first cavity 131 communicates with the connecting space S via the first opening 132. The second connection segment 23 further has a second cavity 231 formed in the second connection segment 23 and communicating with the second opening 232. A periphery of the second cavity 231 is formed as a second surrounding wall 233 that surrounds the second cavity 231. The second cavity 231 communicates with the connecting space S via the second opening 232.

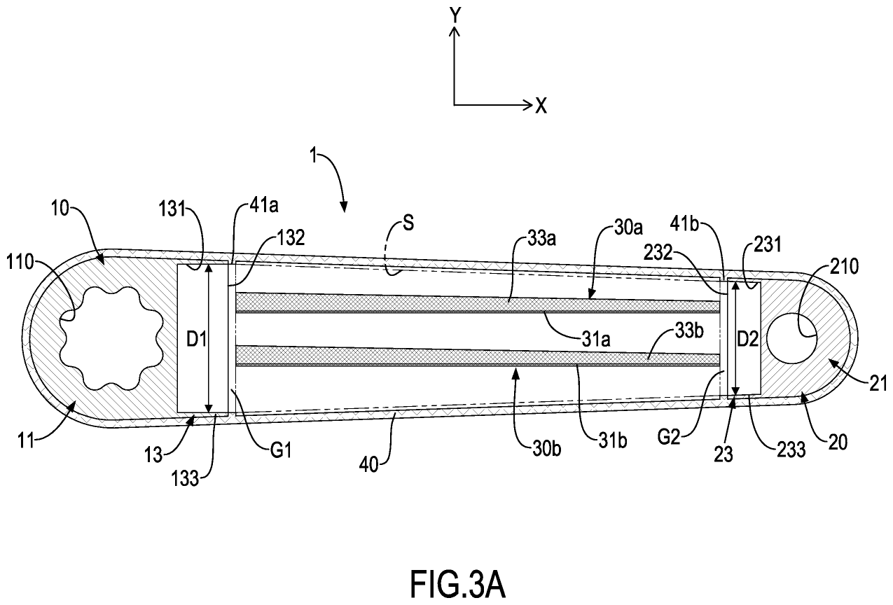

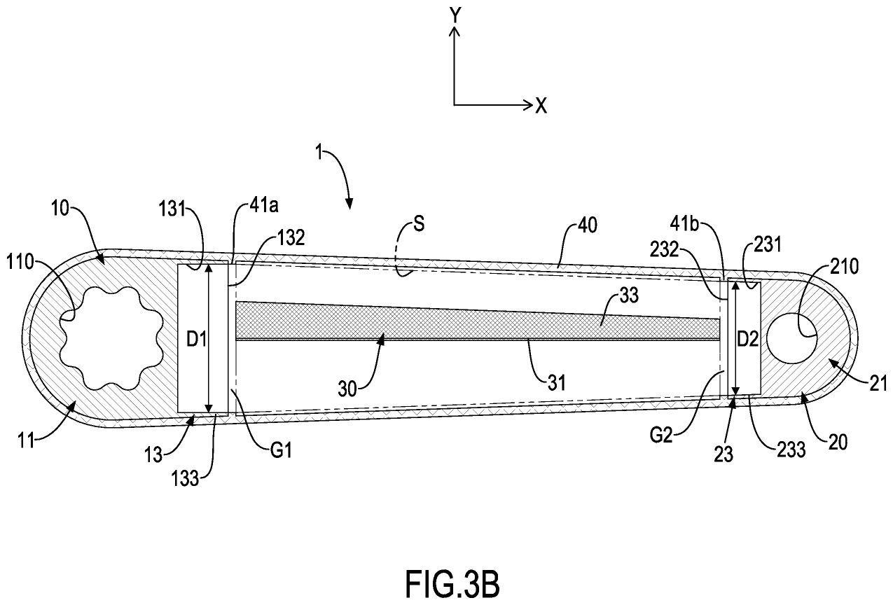

The external fiber member 40 can be fiber resin prepreg (fiber sheet) with carbon fiber, glass fiber, or other fibers and is wrapped on an overall outline of the first metal member 10, the second metal member 20, and the connecting space S. The reinforcement fiber members 30/30a/30b shown in FIGS. 3A/3B and 4A/4C can be fiber resin prepreg (fiber sheet) with carbon fiber, glass fiber, or other fibers. One or multiple reinforcement fiber members 30/30a/30b are disposed between the first metal member 10 and the second metal member 20. Each reinforcement fiber member 30/30a/30b includes two overlaying segments 33/33a/33b and a rib 31/31a/31b. The two overlaying segments 33/33a/33b respectively bond to two opposite inner sides of the external fiber member 40 along the reference axis Z or the thickness direction of the composite crank 1. The rib 31/31a/31b is disposed in the connecting space S and connects with the two overlaying segments 33/33a/33b. In different embodiments, the reinforcement fiber member 30/30a/30b and the two overlaying segments 33/33a/33b and the rib 31/31a/31b thereof substantially extend along a straight connecting line between the first metal member 10 and the second metal member 20 (e.g. the straight composite crank 1 shown in the figures) or along a curved connecting line between the first metal member 10 and the second metal member 20 (e.g. a curved composite crank 1). The two overlaying segments 33/33a/33b extend and bend from the ribs 31/31a/31b, and then bond to the two opposite inner surfaces of the external fiber member 40 along the thickness direction of the composite crank 1.

Preferably, the rib 31/31a/31b of the reinforcement fiber member 30/30a/30b extends along the major axis X (or referred to as the connection direction between the first metal member 10 and the second metal member 20) and the reference axis Z (or referred to as the thickness direction of the composite crank 1). The two overlaying segments 33/33a/33b extend along the major axis X. In this embodiment, longitudinal two ends of the reinforcement fiber member 30/30a/30b are adjacent to the first metal member 10 and the second metal member 20 respectively.

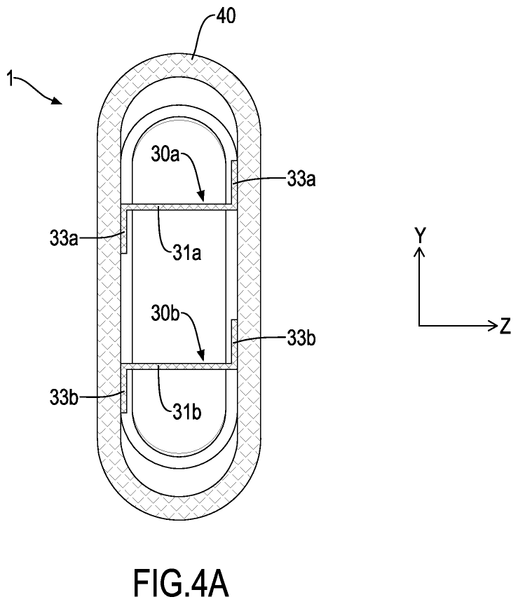

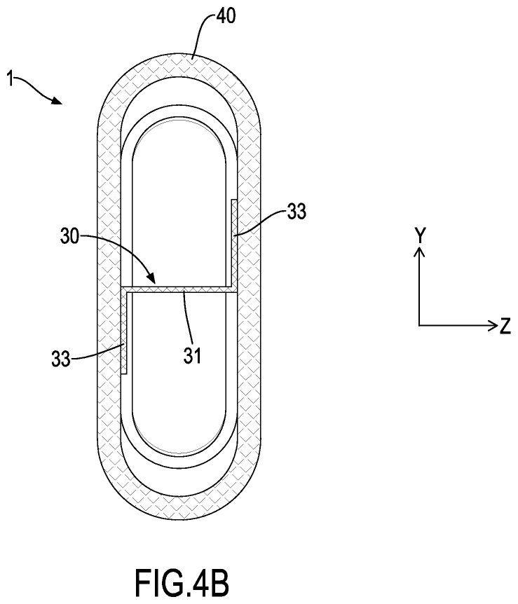

In this embodiment, the two overlaying segments 33/33a/33b of the reinforcement fiber member 30/30a/30b extend from the rib 31/31a/31b toward opposite directions along the minor axis Y (the width direction of the composite crank 1) to form the reinforcement fiber member 30/30a/30b in a Z shape (as shown in FIGS. 4A/4B). The first width D1 of the first connection segment 13 of the first metal member 10 is larger than the second width D2 of the second connection segment 23 of the second metal member 20 (as shown in FIGS. 3A/3B). A width of each of the overlaying segments 33/33a/33b of the reinforcement fiber member 30/30a/30b near the first metal member 10 along the minor axis Y (the width direction of the composite crank 1) is larger than a width of the overlaying segment 33/33a/33b near the second metal member 20 along the minor axis Y (the width direction of the composite crank 1). So strength of the composite crank 1 near the first metal member 10 can be enhanced. In another embodiment, each of the overlaying segments 33/33a/33b may have a constant width.

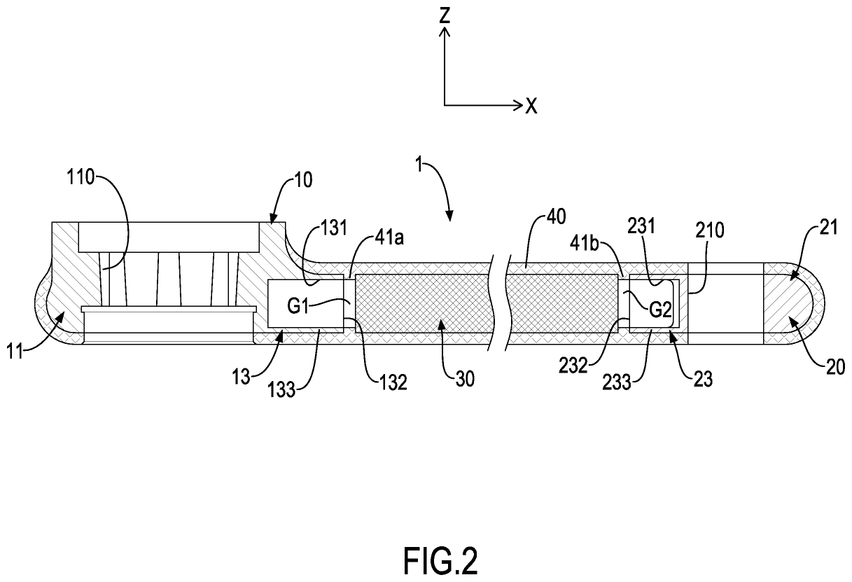

As shown in FIG. 2, the longitudinal two ends of the reinforcement fiber member 30/30a/30b are respectively spaced from the first connection segment 13 of the first metal member 10 and the second connection segment 23 of the second metal member 20 to form gaps G1/G2 therebetween. The external fiber member 40 has two annular ribs 41a/41b in the gaps G1/G2. The annular rib 41a is formed between one of the longitudinal ends of the reinforcement fiber member 30/30a/30b and the first connection segment 13 of the first metal member 10. The annular rib 41b is formed between the other one of the longitudinal ends of the reinforcement fiber member 30/30a/30b and the second connection segment 23 of the second metal member 20.

The external fiber member 40 is wrapped on the first metal member 10 having a hollow first connection segment 13, the second metal member 20 having a hollow second connection segment 23, and the connecting space S therebetween to decrease the weight of the composite crank 1. The structural strength of the composite crank 1 along the thickness direction thereof can be enhanced via the reinforcement fiber member 30/30a/30b formed in the connecting space S. The composite crank 1 in accordance with the present invention has a light weight and the structural strength in the thickness direction thereof can be enhanced.

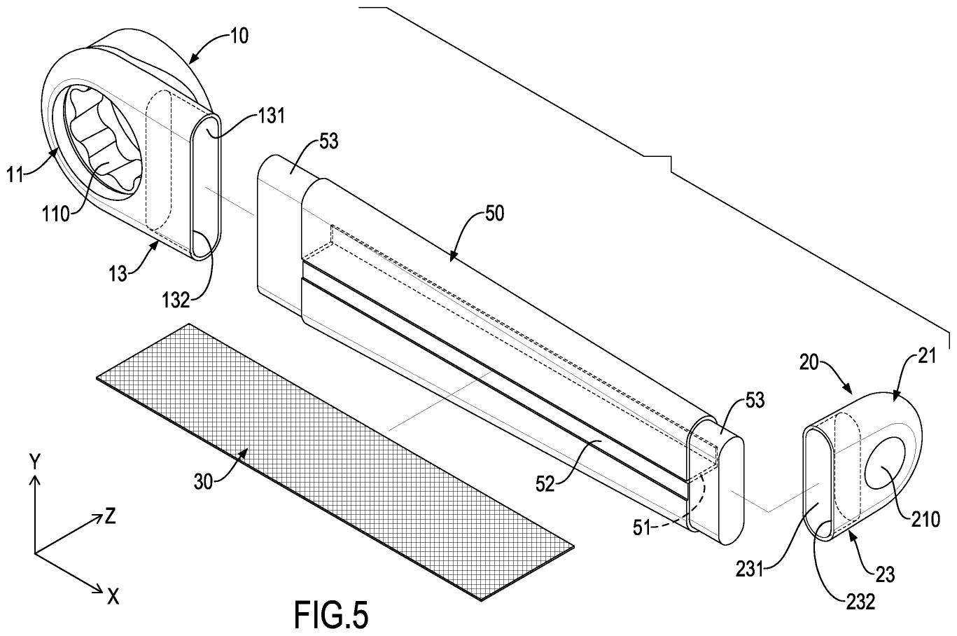

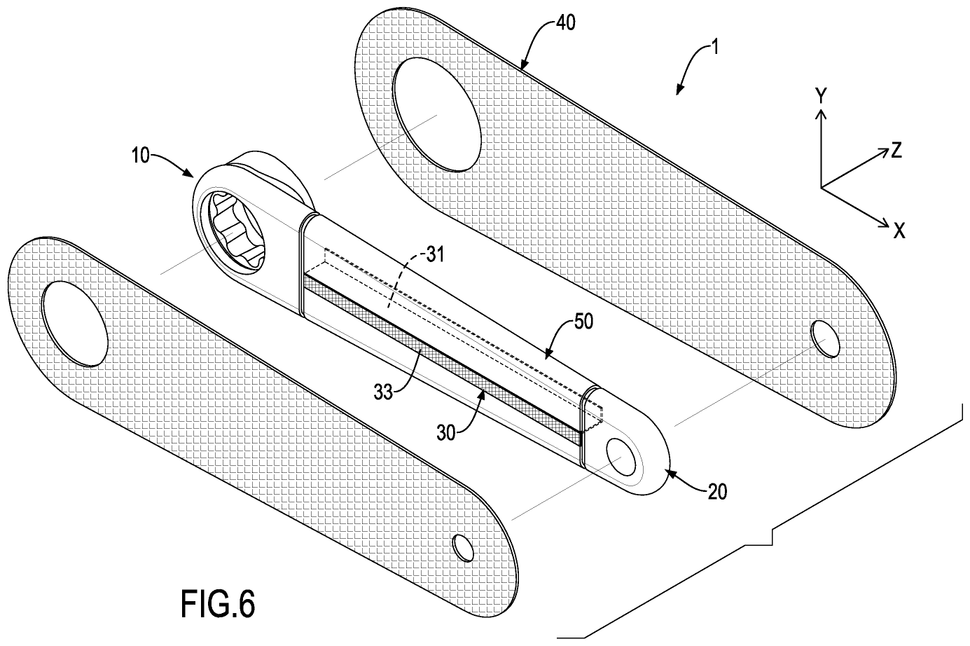

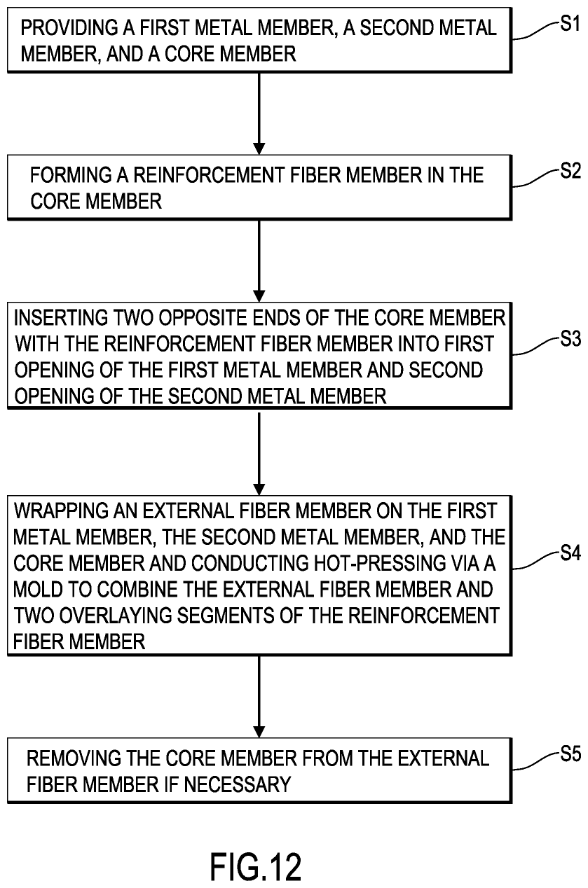

With reference to FIGS. 5, 6 and 12, a method for manufacturing the composite crank 1 comprises steps as follows. The following descriptions are substantially based on manufacturing methods. For the structures or the features that are not described, please refer to the drawings of the embodiments and the corresponding descriptions. The features or structures of other embodiments that are not directly mentioned in the following manufacturing method can also be implemented by one having ordinary skill in the art applying the following process steps with the descriptions of the features or the structures.

Step S1: Providing a first metal member 10, a second metal member 20, and an elongated core member 50. For the convenience of description, a straight composite crank 1 is described as an example. The major axis X, the minor axis Y, and the reference axis Z being perpendicular to each other are referred to as reference directions. As mentioned above, the composite crank 1 may be curved, twisted, or deflected in different embodiments, and may have variable width/thickness. So the major axis X can be replaced with a straight or curved connecting direction between the first metal member 10 and the second metal member 20. The minor axis Y can be replaced with a width direction of the composite crank 1. The reference axis Z can be replaced with a thickness direction of the composite crank 1. The connecting direction, the width direction, and the reference axis Z mentioned above are not necessary to be perpendicular to each other to form a composited crank 1 that is curved, twisted, deflected, or has variable width/thickness.

The first metal member 10 can be an aluminum member to connect to a five-way hub of a bicycle and has a first connecting hole portion 11 and a first connection segment 13. The first connecting hole portion 11 is has a first connecting hole 110 defined therein and extending along a reference axis Z. The first connection segment 13 extends from the first connecting hole portion 11 along a major axis X and has a first opening 132 formed in an end thereof away from the first connecting hole portion 11. The major axis X is perpendicular to the reference axis Z. The first connection segment 13 has a first cavity 131 formed therein and communicating with the first opening 132.

The second metal member 20 is an aluminum member to connect to a pedal of the bicycle and has a second connecting hole portion 21 and a second connection segment 23. The second connecting hole portion 21 has a second connecting hole 210 defined therein and extending along the reference axis Z. The second connection segment 23 extends from the second connecting hole portion 21 along the major axis X and has a second opening 232 formed in an end thereof away from the second connecting hole portion 21. The second connection segment 23 has a second cavity 231 formed therein and communicating with the second opening 232.

The core member 50 can be made of wax or foam material. The core member 50 made of wax is removable. The core member 50 extends along the major axis X. Each of two opposite ends of the core member 50 along the major axis X has an inserting portion 53 protruding therefrom. The core member 50 has a slit 51 and two recesses 52. The slit 51 is an elongated and narrow through hole and extends along the major axis X and the reference axis Z or the thickness direction of the composite crank 1/the core member 50. The two recesses 52 are respectively recessed in two opposite side surfaces of the core member 50 along the reference axis Z or the thickness direction of the composite crank 1/the core member 50, communicate with the slit 51, and extend from the slit 51 along the minor axis Y.

Step S2: Forming a reinforcement fiber member 30 in the core member 50. The reinforcement fiber member 30 may be a fiber resin prepreg formed as the fiber sheet as mentioned above, is mounted through the slit 51 of the core member 50, and segments of the reinforcement fiber member 30 respectively protruding from two opposite sides of the core member 50 along the reference axis Z are bended to respectively overlay on two opposite surfaces of the core member 50 along the reference axis Z, and are respectively mounted in the two recesses 52 of the core member 50. Thus, the segment of the reinforcement fiber member 30 extending through the core member 50 is formed as a rib 31, and the two segments of the reinforcement fiber member 30 respectively overlaying on the two opposite sides of the core member 50 along the reference axis Z are formed as two overlaying segments 33.

Step S3: Inserting two opposite ends of the core member 50 with the reinforcement fiber member 30 into the first opening 132 of the first metal member 10 and the second opening 232 of the second metal member 20 respectively. The two opposite ends of the core member 50 along the major axis X are inserted in the first opening 132 of the first metal member 10 and the second opening 232 of the second metal member 20 respectively, and the inserting portions 53 are respectively inserted in the first cavity 131 of the first metal member 10 and the second cavity 231 of the second metal member 20. An external surface of the core member 50 is aligned with external surfaces of the first metal member 10 and the second metal member 20. The overlaying segments 33 of the reinforcement fiber member 30 are aligned with the opposite external surfaces of the first metal member 10 and the second metal member 20 along the reference axis Z.

Step S4: Wrapping an external fiber member 40 on the first metal member 10, the second metal member 20, and the core member 50, and conducting hot pressing via a mold. The external fiber member 40 may include one or multiple fiber resin prepregs formed as fiber sheets as mentioned above. After the external fiber member 40 is wrapped around a semi-product assembled by the first metal member 10, the second metal member 20, and the core member 50 with the reinforcement fiber member 30, the external fiber member 40 will overlay on the two overlaying segments 33 of the reinforcement fiber member 30. After that, the semi-product wrapped with the external fiber member 40 is putted into a mold to conduct hot pressing. During the hot pressing process, high temperature heat in the mold is transferred to the reinforcement fiber member 30 via the external fiber member 40. The fiber resin prepregs of the external fiber member 40 and the fiber resin prepreg of the reinforcement fiber member 30 are solidified. The external fiber member 40, the first metal member 10, the second metal member 20, the core member 50, and the reinforcement fiber member 30 are combined as one piece.

Step S5: Removing the core member 50 from the external fiber member 40 if needed. If the core member 50 is made of wax, the manufacturing method of the present invention further comprises providing a dewaxing hole and hot melting and removing the core member 50 from the external fiber member 40. To remove the core member 50, a hole is drilled in the external fiber member 40 at a position corresponding to the core member 50, and then the crank having a hole is putted into an oven and is heated to melt the wax. The melting core member 50 flows out from the external fiber member 40 via the hole, and the space where the core member 50 has been disposed is formed as a hollow connecting space S. Thus, a hollow composite crank 1 having a reinforcing rib can be manufactured. Because melting wax can flow out via a small hole, the hole can be filled to keep a high structural strength. The core member 50 does not remain in the composite crank 1 to increase the weight or knocking sound. The hole is located not only at a position where the core member 50 is not inserted into the first metal member 10 and the second metal member 20, but at the first metal member 10 or the second metal member 20 if necessary. If the core member 50 is made of foam material, the core member 50 will be compressed to fix on the reinforcement fiber member 30 after hot-pressing process. Although the core member 50 is not removed, noise will not be generated.

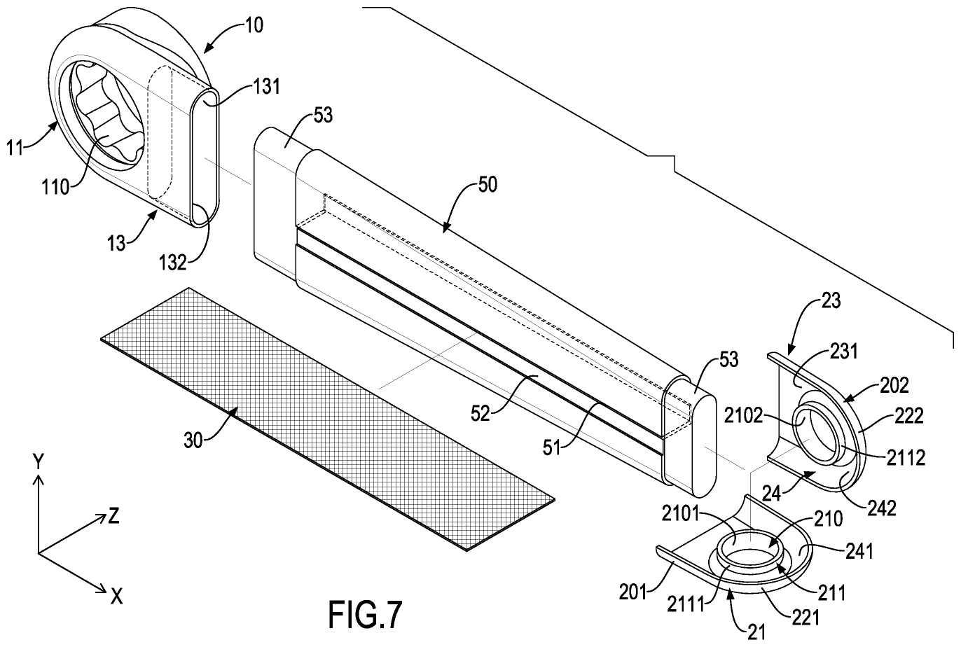

With reference to FIG. 7, in a second embodiment of the present invention, the second connecting hole portion 21 of the second metal member 20 has an annular groove 24 surrounding the second connecting hole 210, separated from the second connecting hole 210 by a hole wall 211, and communicating with the second cavity 231. The weight of the composite crank 1 can be further decreased via the annular groove 24. Particularly, the second metal member 20 comprises two sub-metal members 201, 202 arranged along the reference axis Z or the thickness direction of the composite crank 1 and aligned with each other. Each of the two sub-metal members 201, 202 has a sub-external-surrounding wall 221, 222 and a protrusion. The sub-external-surrounding wall 221, 222 is formed on an exterior of the sub-metal member 201, 202. The protrusion protrudes from one of the sub-metal members 201, 202, and extends along the reference axis Z or the thickness direction of the composite crank 1 toward the other one of the sub-metal members 201, 202 to abut against the protrusion of the other one of the sub-metal members 201, 202. A sub-annular groove 241, 242 is formed between the protrusion and the sub-external-surrounding wall 221, 222. A sub-connecting hole 2101, 2102 is formed in the protrusion and extends along the reference axis Z or thickness direction of the composite crank 1 to form a sub-hole wall 2111, 2112 surrounding the sub-connecting holes 2101, 2102. The sub-hole walls 2111, 2112 of the two sub-metal members 201, 202 abut against each other to form the hole wall 211 of the second metal member 20. The sub-connecting holes 2101, 2102 of the sub-metal members 201, 202 are aligned with each other and communicate with each other to form the second connecting hole 210 of the second metal member 20. The sub-annular grooves 241, 242 of the two sub-metal members 201, 202 communicate with each other to form the annular groove 24 surrounding the hole wall 211.

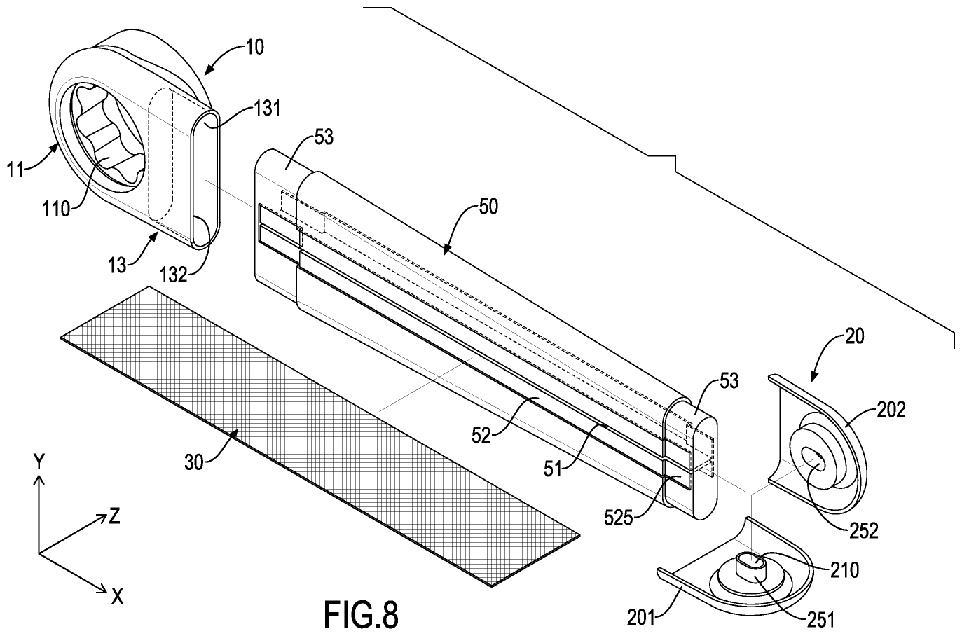

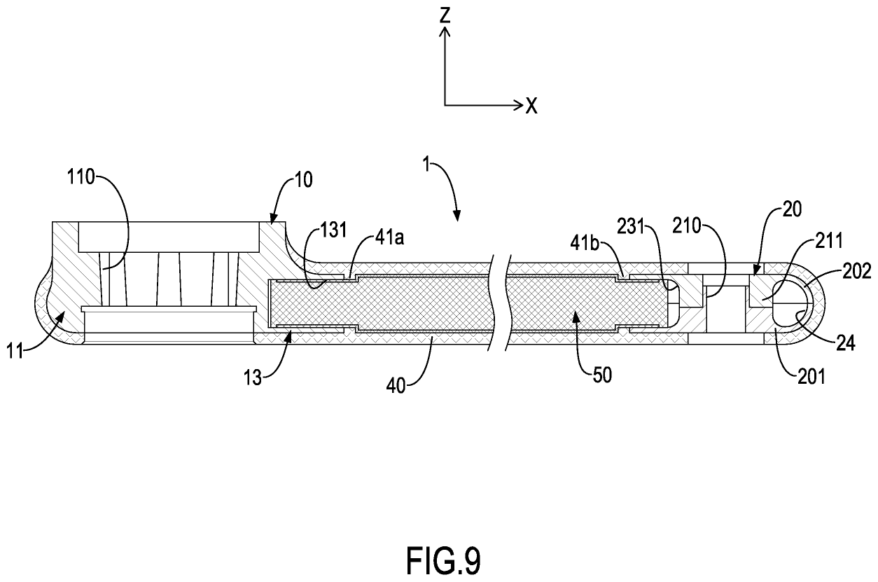

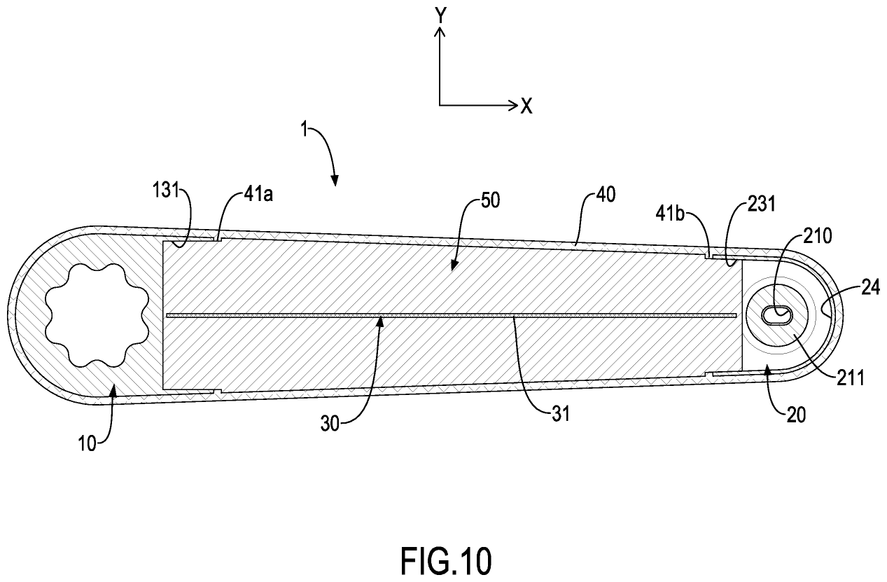

With reference to FIGS. 8 to 10, in a third embodiment of the present invention, a final product of the composite crank 1 may comprise a core member 50. The core member 50 may be made of foam resin and is disposed in the connecting space S. Two opposite ends of the core member 50 are respectively inserted in the first opening 132 of the first metal member 10 and the second opening 232 of the second metal member 20. The rib 31 of the reinforcement fiber member 30 is inserted through the core member 50. The core member 50 can hold the reinforcement fiber member 30 in the connecting space S to increase the structural strength of the composite crank 1 during hot-pressing process via the mold.

A method for manufacturing the composite crank 1 with the core member 50 comprises steps as follows. Assemble the first metal member 10, the second metal member 20, the core member 50, and the reinforcement fiber member 30. Then, wrap the external fiber member 40 on and around the first metal member 10, the second metal member 20, and the core member 50, and the external fiber member 40 is combined with the two overlaying segments 33 of the reinforcement fiber member 30. Thus, the composite crank 1 with the core member 50 is produced. The core member 50 does not need to be removed from the external fiber member 40. If the core member 50 is made of foam material, the core member 50 is compressed to fix on the reinforcement fiber member 30 during hot-pressing process. Although the core member 50 is not removed, noise will not be generated.

Preferably, the rib 31 of the reinforcement fiber member 30 extends into the first cavity 131 of the first metal member 10 and the second cavity 231 of the second metal member 20 to combine with the first metal member 10 and the second metal member 20 to increase structural strength. The two overlaying segments 33 of the reinforcement fiber member 30 respectively bond to two opposite sides of the first cavity 131 of the first metal member 10 along the reference axis Z and two opposite sides of the second cavity 231 of the second metal member 20 along the reference axis Z. The slit 51 of the core member 50 extends to the inserting portions 53 of the core member 50. Each inserting portion 53 has two insertion grooves 525 respectively recessed in two opposite sides of the inserting portion 53 along the reference axis Z. Each insertion groove 525 communicates with a corresponding one of the recesses 52 to form a step therebetween. Each overlaying segment 33 of the reinforcement fiber member 30 can extend along the step to dispose in the recess 52 and the insertion groove 525 and selectively bonds to the surface of the first cavity 131 of the first metal member 10 and the surface of the second cavity 231 of the second metal member 20. A step is formed between each of two end segments of each of the overlaying segments 33 of the reinforcement fiber member 30 that are respectively inserted in the first cavity 131 and the second cavity 231 and a main segment of the overlaying segment 33 that is not inserted in the first cavity 131 and the second cavity 231. Adhesives can be pasted on the overlaying segments 33 of the reinforcement fiber member 30 between the first cavity 131 and the second cavity 231 to firmly bond the overlaying segments 33 of the reinforcement fiber member 30 to the surfaces of the first cavity 131 and the second cavity 231. In different embodiments, the rib 31 and/or the two overlaying segments 33 of the reinforcement fiber member 30 can extend alone or together into the first cavity 131 of the first metal member 10 and the second cavity 231 of the second metal member 20.

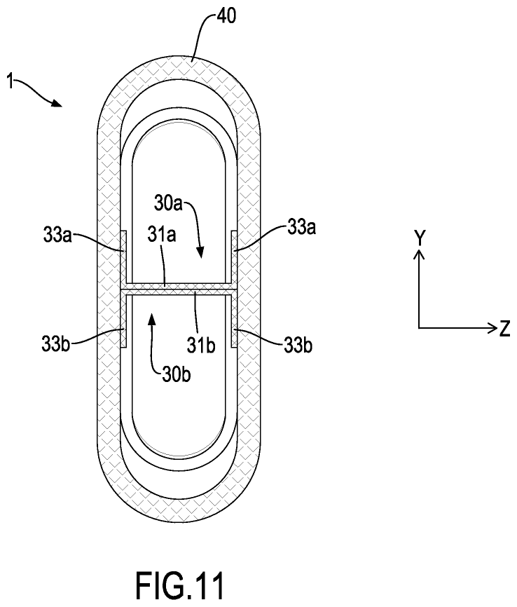

In different embodiments, the method for manufacturing the composite crank 1 in accordance with present invention comprises a step of bending the two overlaying segments 33 of the reinforcement fiber member 30 respectively from two longitudinal edges of the rib 31 to extend along the width direction of the composite crank 1. That is, the two overlaying segments 33a of one single reinforcement fiber member 30a extend toward the same direction (as shown in FIG. 11), the two overlaying segments 33 of one single reinforcement fiber member 30 respectively extend toward opposite directions (as shown in FIGS. 4A/4B), or the overlaying segments 33a/33b of two reinforcement fiber members 30a/30b at the same side extend along the minor axis Y (the width direction) toward opposite directions from the ribs 31 as shown in FIG. 11. In different embodiments, the method for manufacturing the composite crank 1 of the present invention may comprise a step of inserting the rib 31 and/or the two overlaying segments 33 of the reinforcement fiber member 30 into the first opening 132 of the first metal member 10 and the second opening 232 of the second metal member 20. In another embodiment, the first connection segment 13 of the first metal member 10 has a first cavity 131, and the second connection segment 23 of the second metal member 20 has a second cavity 231. The method for manufacturing the composite crank 1 comprises a step of inserting the two overlaying segments 33 of the reinforcement fiber member 30 into the first cavity 131 of the first metal member 10 via the first opening 132 and the second cavity 231 of the second metal member 20 via the second opening 232 and bonding the overlaying segments 33 on the surfaces of the first cavity 131 of the first metal member 10 and the second cavity 231 of the second metal member 20.

Preferably, one of the two sub-metal members 201, 202 of the second metal member 20 has at least one concave portion 252 and the other one of the two sub-metal members 201, 202 has at least one convex portion 251 engaged with the at least one concave portion 252 to enhance convenience and stability of assembly.

With reference to FIG. 11, in a fourth embodiment of the present invention, the overlaying segments 33a/33b of two reinforcement fiber members 30a/30b at the same side extend along the minor axis Y (width direction) from the edges of the ribs 31 to opposite directions. The whole reinforcement fiber members 30a/30b has an H-shaped cross section. For example, two carbon fiber prepregs are bended to be U-shaped and inverted U-shaped respectively and are solidified by hot-pressing mold to combine as the H-shaped reinforcement fiber members 30a/30b. The structural strength of the composite crank 1 can be enhanced via the H-shaped reinforcement fiber members 30a/30b. Comparing FIG. 11 and FIGS. 4A/4B, in FIGS. 4A/4B, the two overlaying segments 33/33a/33b of one single reinforcement fiber member 30/30a/30b are respectively bended from two longitudinal edges of the rib 31/31a/31b and extend to the same or opposite directions (along the minor axis Y or the width direction of the composite crank 1). In addition, the Z-shaped reinforcement fiber member 30a/30b in FIGS. 4A/4B can improve load capacity of the curved or twisted composite crank 1 against shear stress in a specific direction.

In other embodiments, under a suitable manufacturing method, the overlaying segments 33/33a/33b bonded to the two opposite inner surfaces of the external fiber member 40 may not require bending and surface bonding areas. The overlaying segments 33/33a/33b can be two edge surfaces of the rib 31/31a/31b bonded to the two inner surfaces of the external fiber member 40. In other words, the reinforcement fiber member 30/30a/30b is formed I-shaped, and the overlaying segments 33/33a/33b do not bend.

The foregoing description is only some preferred embodiments of the present invention, not intended to limit the scope of the present invention. Those skilled in the art would change or modify the foregoing context to obtain equivalent embodiments within the principles of the invention, and the equivalent embodiments are still within the scope of the claimed invention.

What is claimed is:

1. A composite crank comprising:
a first metal member having
a first connecting hole portion having a first connecting hole; and
a first connection segment extending from the first connecting hole portion and having a first opening formed in an end of the first connection segment away from the first connecting hole portion;
a second metal member arranged at a spaced interval from the first metal member to define a connecting space in the composite crank and between the first metal member and the second metal member, the second metal member having
a second connecting hole portion having a second connecting hole; and
a second connection segment extending from the second connecting hole portion and having a second opening formed in an end of the second connection segment away from the second connecting hole portion, wherein the connecting space communicates with the first opening and the second opening;
an external fiber member wrapped on and around the first metal member, the second metal member, and the connecting space; and
a reinforcement fiber member extending along a connecting direction between the first metal member and the second metal member, disposed between the first metal member and the second metal member, and having
two overlaying segments respectively bonding to two opposite inner sides of the external fiber member along a thickness direction of the composite crank; and
a rib disposed in the connecting space and connecting with the two overlaying segments.

2. The composite crank as claimed in claim 1, wherein the rib of the reinforcement fiber member extends along the thickness direction and the connecting direction, and the two overlaying segments extend along the connecting direction and a width direction of the composite crank.

3. The composite crank as claimed in claim 1, wherein the first connection segment of the first metal member has a first cavity formed in the first connection segment and communicating with the connecting space via the first opening; and the second connection segment of the second metal member has a second cavity formed in the second connection segment and communicating with the connecting space via the second opening.

4. The composite crank as claimed in claim 3, wherein the second connecting hole portion of the second metal member has an annular groove surrounding the second connecting hole and separated from the second connecting hole by a hole wall, and communicating with the second cavity.

5. The composite crank as claimed in claim 4, wherein the second metal member comprises two sub-metal members arranged along the thickness direction and aligned with each other.

6. The composite crank as claimed in claim 5, wherein one of the sub-metal members has at least one concave portion and the other one of the two sub-metal members has at least one convex portion engaged with the at least one concave portion.

7. The composite crank as claimed in claim 1, wherein the two overlaying segments of the reinforcement fiber member are bended from two longitudinal edges of the rib and extend along the width direction of the composite crank.

8. The composite crank as claimed in claim 3, wherein the two overlaying segments of the reinforcement fiber member extend to the first cavity of the first metal member and the second cavity of the second metal member.

9. The composite crank as claimed in claim 8, wherein a step is formed between each of two end segments of each of the overlaying segments of the reinforcement fiber member that are respectively inserted in the first cavity and the second cavity and a main segment of the overlaying segment that is not inserted in the first cavity and the second cavity.

10. The composite crank as claimed in claim 1, wherein the first connection segment of the first metal member has a first width along the width direction of the composite crank, the second connection segment of the second metal member has a second width along a width direction of the composite crank, the first width is larger than the second width, and a width of each of the overlaying segments of the reinforcement fiber member near the first metal member along the width direction of the composite crank is larger than a width of the overlaying segment near the second metal member along the width direction of the composite crank.

11. A method for manufacturing a composite crank comprising:
providing a first metal member, a second metal member, and a core member, wherein
the first metal member has
a first connecting hole portion having a first connecting hole; and
a first connection segment extending from the first connecting hole portion and having a first opening formed in an end of the first connection segment away from the first connecting hole portion;
the second metal member has
a second connecting hole portion having a second connecting hole; and
a second connection segment extending from the second connecting hole portion and having a second opening formed in an end of the second connection segment away from the second connecting hole portion;
forming a reinforcement fiber member in the core member, wherein the reinforcement fiber member has a rib and two overlaying segments, the rib is inserted through the core member, the two overlaying segments respectively connect to two opposite edges of the rib and respectively overlay on two opposite side surfaces of the core member along a thickness direction of the core member;
inserting two opposite ends of the core member with the reinforcement fiber member into the first opening of the first metal member and the second opening of the second metal member respectively; and
wrapping an external fiber member on the first metal member, the second metal member and the core member, and conducting hot pressing via a mold to combine the external fiber member with the two overlaying segments of the reinforcement fiber member.

12. The method for manufacturing a composite crank as claimed in claim 11, wherein the core member has a slit and two recesses, the slit extends along a connecting direction between the first metal member and the second metal member and the thickness direction, the two recesses are respectively recessed in the two opposite side surfaces of the core member along the thickness direction and communicate with the slit, the rib of the reinforcement fiber member extends through the slit of the core member, and the two overlaying segments of the reinforcement fiber member are respectively mounted in the two recesses of the core member.

13. The method for manufacturing a composite crank as claimed in claim 11, wherein the core member is made of wax, after wrapping the external fiber member, the method comprises providing a dewaxing hole and hot melting to remove the core member from the external fiber member.

14. The method for manufacturing a composite crank as claimed in claim 11, wherein the core member is made of foam material, and the core member is compressed to fix on the reinforcement fiber member after hot-pressing via the mold.

15. The method for manufacturing a composite crank as claimed in claim 11 comprising a step of bending the two overlaying segments of the reinforcement fiber member respectively from two longitudinal edges of the rib to extend along a width direction of the composite crank.
